(19) United States
(12) Patent Application Publication
(10) Pub. No.: US 2026/0194748 A1
(43) Pub. Date: Jul. 9, 2026

(54) CAMERA MODULE

(71) Applicant: SAMSUNG ELECTRO-MECHANICS CO., LTD., Suwon-si (KR)

(72) Inventors: Min Hyuk IM, Suwon-si (KR); Gil Hun LEE, Suwon-si (KR)

(73) Assignee: SAMSUNG ELECTRO-MECHANICS CO., LTD., Suwon-si (KR)

(21) Appl. No.: 19/557,255

(22) Filed: Mar. 5, 2026

Related U.S. Application Data
(62) Division of application No. 18/092,484, filed on Jan. 3, 2023, now abandoned.

(30) Foreign Application Priority Data
Jun. 14, 2022 (KR) 10-2022-0071981

(51) Int. Cl. G02B 27/00; G02B 7/02; G02B 13/00

(52) U.S. Cl. CPC G02B 27/0018; G02B 7/021; G02B 7/026; G02B 13/002

(57) ABSTRACT

A camera module is provided. The camera module includes at least one lens including a rib surface, a lens barrel configured to accommodate the at least one lens, and an image sensor disposed in an optical axis direction with respect to the at least one lens. The rib surface includes a first region in which a pattern including a curved surface is repeatedly formed on a surface that is perpendicular to the optical axis direction.

### CROSS-REFERENCE TO RELATED APPLICATIONS

This application is a Divisional Application of U.S. Patent Application No. 18/092,484 filed on January 3, 2023, which claims the benefit under 35 USC § 119(a) of Korean Patent Application No. 10-2022-00071981 filed on June 14, 2022, in the Korean Intellectual Property Office, the entire disclosure of which is incorporated herein by reference for all purposes.

### BACKGROUND

### 1. Field

The following description relates to a camera module.

### 2. Description of Related Art

Recently, a camera module has been typically installed in mobile communication terminals such as, but not limited to, smartphones. Such a camera module may be provided with a plurality of lenses, and light, passing through the plurality of lenses, is condensed by an image sensor to form an image.

Light reflected from a subject to be incident on the interior of the camera module may be refracted while passing through the plurality of lenses. In this example, when the refracted light is reflected from optical equipment such as a rib surface of a lens or a press-fit ring to be incident on the image sensor, a flare phenomenon may occur.

When such a flare phenomenon occurs, the quality of the captured image is lowered. For example, blurring or round white spots may appear in the captured image. In particular, with the recent trend of miniaturizing mobile communication terminals, the size of each component of the camera module has been decreasing. Accordingly, the frequency of unintentional reflected light beams occurring in the camera module has been increasing.

Typically, in order to solve the flare phenomenon, corrosion treatment is performed on a rib surface of a lens to induce diffuse reflection. However, a pattern formed through the corrosion treatment has a limitation in diffusely reflecting all lights incident on the rib surface or the like, and the same level of flare may not be guaranteed for all products.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

In a general aspect, a camera module includes at least one lens comprising a rib surface; a lens barrel configured to accommodate the at least one lens; and an image sensor disposed in an optical axis direction with respect to the at least one lens, wherein the rib surface comprises a first region in which a pattern including a curved surface, is repeatedly formed on a surface that is perpendicular to the optical axis direction.

The rib surface further may include a second region in which the pattern is not formed on the surface that is perpendicular to the optical axis direction, and the second region may be disposed at a distance that is greater than a distance of the first region from the optical axis.

Portions of the rib surface that are positioned at a same distance from the optical axis in the first region may be configured to have a same inclination with respect to the optical axis direction.

The pattern may be repeatedly formed at least two times from an inner diameter of the rib surface to an outer diameter of the rib surface.

The pattern may include protrusion portions that protrude toward an object-side of the camera module and groove portions that protrude toward an image-side of the camera module, and a distance in a direction, perpendicular to the optical axis direction, between adjacent protrusion portions or adjacent the groove portions, may be greater than a distance in the optical axis direction between the adjacent protrusion portions and the adjacent groove portions.

At least some of portions of the pattern positioned at a same distance from the optical axis in the first region may be configured to have different inclinations with respect to the optical axis direction.

The pattern may include one of an embossed portion that protrudes toward an object, and an engraved portion that protrudes toward an image.

A maximum length of the embossed portion or the engraved portion in a direction perpendicular to the optical axis, may be greater than a maximum length of the embossed portion or the engraved portion in a direction parallel to the optical axis direction.

At least one of the embossed portion and the engraved portion may be formed at a predetermined angular interval along a circumference of a circle centered on the optical axis.

The embossed portion may be continuously formed from an inner diameter of the rib surface to an outer diameter of the rib surface along a circumference of a circle centered on the optical axis.

In a general aspect, a camera module includes at least one lens; a lens barrel configured to accommodate the at least one lens; a press-fit ring disposed on the lens barrel, and configured to fix the at least one lens; and an image sensor disposed in an optical axis direction with respect to the at least one lens, wherein the press-fit ring comprises a first region in which a pattern including a curved surface is repeatedly formed on an inner circumferential surface thereof.

Portions of the pattern positioned at a same distance from the optical axis in the first region may be configured to have a same inclination with respect to the optical axis direction.

At least some of portions of the pattern positioned at a same distance from the optical axis in the first region may be configured to have different inclinations with respect to the optical axis direction.

The pattern may include a protrusion portion that protrudes toward the optical axis and a groove portion that protrudes toward an inner circumferential surface of the lens barrel.

The pattern may include one of an embossed portion that protrudes toward the optical axis, and an engraved portion that is recessed from the inner circumferential surface.

The at least one lens may include a rib surface, and the rib surface may include the first region disposed on a surface that is perpendicular to the optical axis direction.

The pattern may be a wave-shaped pattern which spreads from an object-side to an image-side on the inner circumferential surface of the press-fit ring.

Other features and aspects will be apparent from the following detailed description, the drawings, and the claims.

### BRIEF DESCRIPTION OF DRAWINGS

FIG. 1 illustrates a cross-sectional view of an example camera module, in accordance with one or more embodiments.

FIG. 2A and FIG. 2B illustrate plan views of a rib surface of an example lens, in accordance with one or more embodiments.

FIG. 3, FIG. 4, FIG. 5, FIG. 6A, FIG. 6B, FIG. 7A, FIG. 7B, FIG. 8A, and FIG. 8B are enlarged views of a first region of a rib surface of an example lens, in accordance with one or more embodiments.

FIG. 9 illustrates a cross-sectional view of an example camera module, in accordance with one or more embodiments.

FIG. 10A, FIG. 10B, FIG. 11A, FIG. 11B, FIG. 12A, FIG. 12B, FIG. 13A, and FIG. 13B are enlarged views of a first region of a press-fit ring, in accordance with one or more embodiments.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween. Likewise, expressions, for example, "between" and "immediately between" and "adjacent to" and "immediately adjacent to" may also be construed as described in the foregoing.

The terminology used herein is for the purpose of describing particular examples only, and is not to be used to limit the disclosure. As used herein, the singular forms "a," "an," and "the" are intended to include the plural forms as well, unless the context clearly indicates otherwise. As used herein, the term "and/or" includes any one and any combination of any two or more of the associated listed items. As used herein, the terms "include," "comprise," and "have" specify the presence of stated features, numbers, operations, elements, components, and/or combinations thereof, but do not preclude the presence or addition of one or more other features, numbers, operations, elements, components, and/or combinations thereof. The use of the term "may" herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

One or more examples provide a camera module in which a flare phenomenon is alleviated.

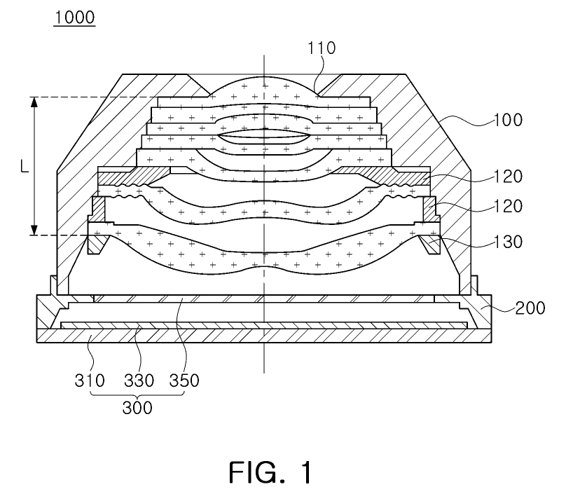

FIG. 1 illustrates a cross-sectional view of an example camera module, in accordance with one or more embodiments.

Referring to FIG. 1, the example camera module 1000 may include a lens module 100, a housing 200, and an image sensor module 300.

The lens module 100 may be accommodated in the housing 200. For example, the housing 200 may have an inner space with open upper and lower portions, and the lens module 100 may be accommodated in the inner space of the housing 200.

In a non-limited example, the image sensor module 300 may be disposed below the housing 200. For example, the image sensor module 300 may include a printed circuit board 310 and an image sensor 330 fixedly mounted on the printed circuit board 310. The image sensor 330 may be electrically connected to the printed circuit board 310.

The image sensor 330 may convert light incident through the lens module 100 into an electrical signal. For example, the image sensor 330 may be, as non-limiting examples, a charge coupled device (CCD) or a complementary metal-oxide semiconductor (CMOS). The electrical signal converted by the image sensor 330 may be output as an image through a display of a portable electronic device.

The image sensor module 300 may further include an infrared filter 350. The infrared filter 350 may block light in an infrared region among the light incident through the lens module 100.

The lens module 100 may include a lens barrel 110 and at least one lens L disposed in the lens barrel 110. For example, the lens barrel 110 may have a cylindrical shape having a hollow portion, and the at least one lens L may be disposed in the hollow portion of the lens barrel 110 in an optical axis direction.

The at least one lens L may include an optical surface and a rib surface. An optical surface LO may be a region for refracting light reflected from a subject, and a rib surface LL may be a region for fixing a lens to the lens barrel 110.

When a plurality of lenses are disposed in the lens barrel 110, the plurality of lenses disposed in the lens barrel 110 may have different diameters, and the lens barrel 110 may have at least an inner circumferential surface formed to be stepped to accommodate the plurality of lenses having various diameters. For example, the lens barrel 110 may have various inner diameters.

In an example, as illustrated in FIG. 1, seven lenses may be disposed in the lens barrel 110. However, the number of lenses may vary depending on the degree of performance to be implemented, and the one or more examples are not limited to the number of lenses.

Referring to FIG. 1, the plurality of lenses L may be sequentially stacked in the lens barrel 10 in the optical axis direction.

One or more spacers 120 may be disposed between the plurality of lenses L to maintain an interval between the lenses. The spacer 120 may block unnecessary light while maintaining the interval between the lenses. To this end, a light blocking material may be coated on the spacer 120 or a light blocking film may be attached to the spacer 120.

Although the drawings illustrate that spacers 120 are only disposed between a fifth lens and a sixth lens and between a sixth lens and a seventh lens, this is only an example, and a spacer may be disposed between other lenses, and may have various shapes and thicknesses depending on the interval between the lenses.

Additionally, a press-fit ring 130, that fixes the plurality of lenses L, may be disposed in the lens barrel 110. For example, the press-fit ring 130 may be disposed below a lens disposed farthest from the subject to be imaged among the plurality of lenses L.

Light, reflected from the subject to be incident on an interior of the lens barrel 110, may be refracted while passing through the plurality of lenses L. In this example, when the refracted light is reflected from optical equipment in the lens barrel 110, such as a rib surface of a lens or a press-fit ring, to be incident on an image sensor, a flare phenomenon may occur.

In one or more examples, the camera module 1000 may include a structure that induces diffuse reflection in the barrel 110 so as to alleviate a flare phenomenon occurring when light, passing through the plurality of lenses L, is reflected from optical equipment in the lens barrel 110.

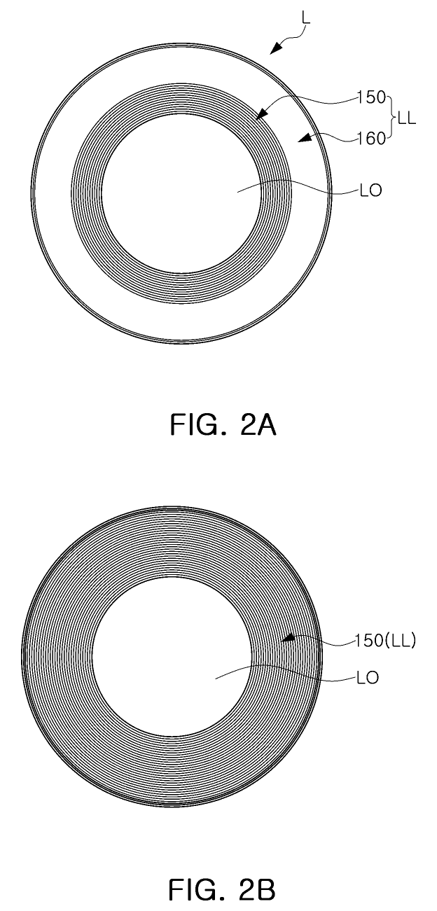

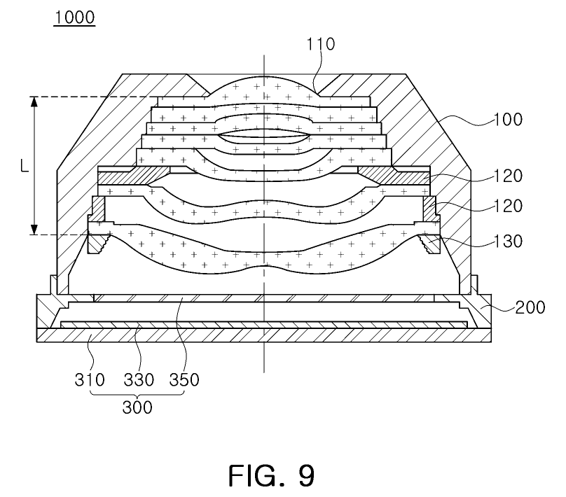

In an example, the camera module 1000 may include a structure that induces diffuse reflection with respect to at least one of the rib surface LL of the lens and the press-fit ring 130. FIG. 1 is an example embodiment including a structure that induces diffuse reflection with respect to the rib surface LL of the lens. FIG. 9 is an example embodiment including a structure that induces diffuse reflection with respect to the press-in ring 130. In the following description with respect to FIG. 2, the first region 150 may refer to a region including a structure that induces diffuse reflection.

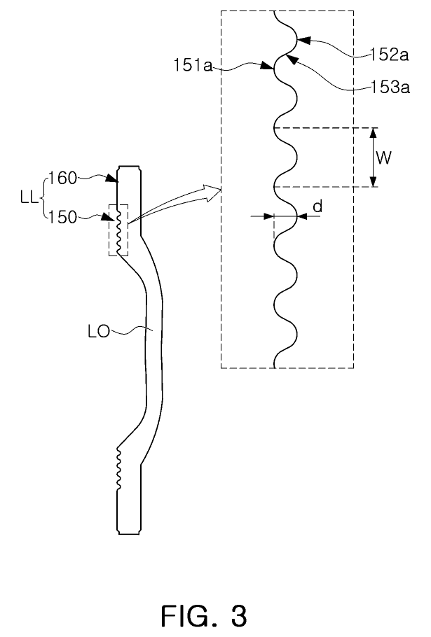

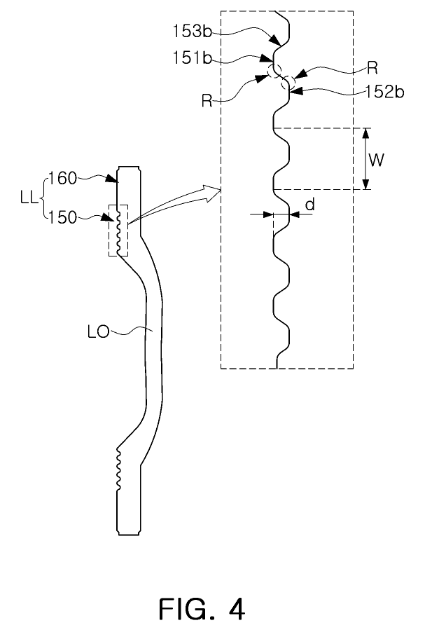

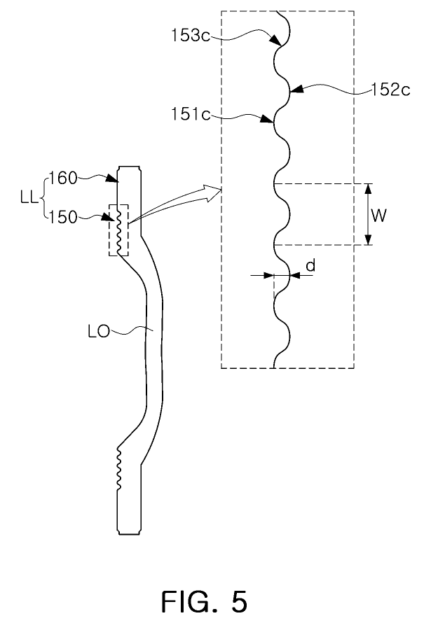

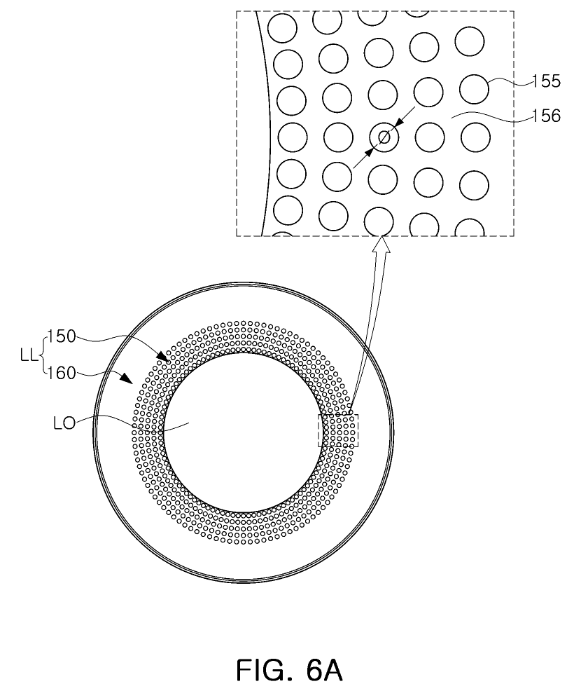

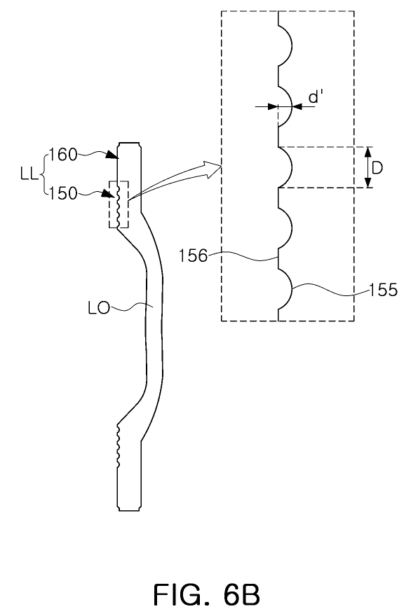

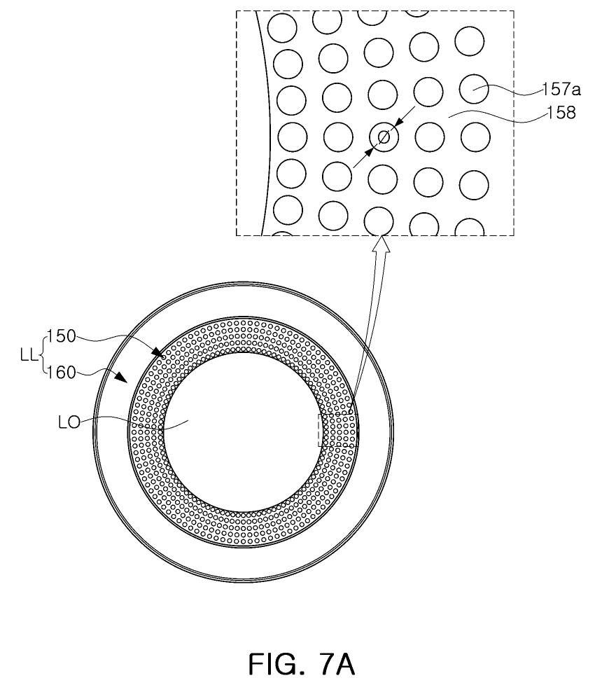

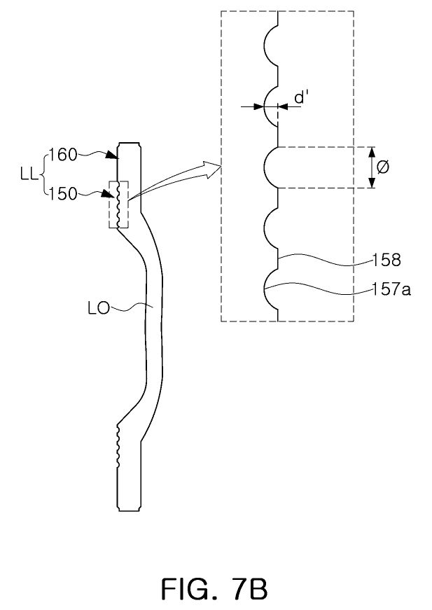

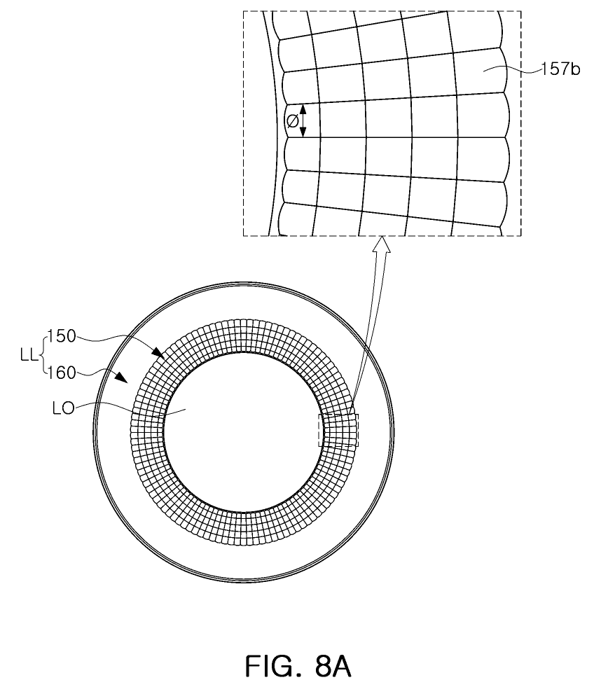

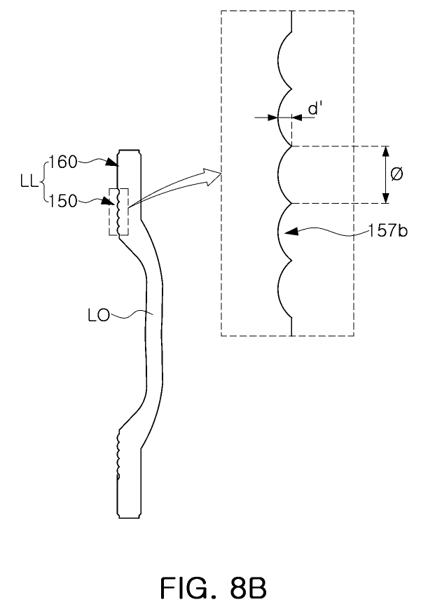

FIGS. 2A and 2B illustrate plan views of a rib surface of a lens, in accordance with one or more embodiments. FIGS. 3 to 8B are enlarged views of a first region of a rib surface of a lens, in accordance with one or more embodiments.

In an example, a first region 150 may be a region in which a pattern including a curved surface is repeatedly formed. The pattern of the first region 150 may have a curved cross-section, and the first region 150 may be a region in which a uniform or regular pattern including a curved surface is repeatedly formed. FIGS. 3 to 8B illustrate various example embodiments of the first region 150, and descriptions related thereto will be described below.

Referring to FIGS. 2A and 2B, the rib surface LL of the lens may include the first region 150 on a surface thereof, perpendicular to an optical axis direction. The first region 150 may be formed on a portion of the rib surface LL, as illustrated in FIG. 2A, or may be formed on the entire rib surface LL, as illustrated in FIG. 2B.

In an example as illustrated in FIG. 2A, the rib surface LL may further include a second region 160 in which the pattern is not formed on the surface thereof, perpendicular to the optical axis direction. Preferably, the second region 160 may refer to a flat region in which a pattern is not formed.

According to the example embodiment illustrated in FIG. 2A, the rib surface LL may include the first region 150 and the second region 160 on the surface thereof, perpendicular to the optical axis direction. Additionally, the second region 160 may be disposed at a distance greater than a distance of the first region 150 from an optical axis on the surface, perpendicular to the optical axis direction of the rib surface LL.

In other words, a shortest distance from the optical axis to the second region 160 may be longer than a shortest distance from the optical axis to the first region 150, and the shortest distance from the optical axis to the second region 160 may be equal to or greater than a longest distance from the optical axis to the first region 150.

A flare phenomenon may occur when light reflected from optical equipment in the lens barrel 110, such as the rib surface LL of the lens, is incident on the image sensor 330. As a reflection surface is closer to the optical axis, the light reflected may be highly likely to be incident on an image surface of the image sensor 330. Thus, the rib surface LL may include the first region 150 at least on an inner diameter side thereof adjacent to the optical axis.

Hereinafter, various example embodiments of the pattern formed in the first region 150 will be described.

FIGS. 3 to 5 illustrate a wave-shaped pattern. Referring to FIGS. 3 to 5, the first region 150 may include a wave-shaped pattern spreading from an inner diameter to an outer diameter of the rib surface LL. The pattern may be repeatedly formed at least two times from the inner diameter to the outer diameter of the rib surface LL.

Referring to FIGS. 3 to 5, the pattern may include a protrusion portion 151 (151a, 151b, 151c) that protrudes toward an object-side (or a subject), and a groove portion 152 (152a, 152b, 152c) that protrude toward an imaging-side (or an image sensor side). For example, the protrusion portion 151 (151a, 151b, 151c) and the groove portion 152 (152a, 152b, 152c) may be repeatedly formed at least two times from the inner diameter to the outer diameter of the rib surface LL.

In one or more examples, the protrusion portion 151 (151a, 151b, 151c) and the groove portion 152 (152a, 152b, 152c) may be repeatedly formed from the inner diameter to the outer diameter in a circumferential direction of the rib surface LL. In the first region 150, portions of the protrusion portion 151 (151a, 151b, 151c) and the groove portion 152 (152a, 152b, 152c) that are positioned at a same distance from the optical axis may have a same inclination with respect to an optical axis direction. In an example, the portions positioned at the same distance from the optical axis in the first region 150 may be the protrusion portion 151 (151a, 151b, 151c) or the groove portion 152 (152a, 152b, 152c).

In one or more examples, a pattern including the protrusion portion 151 (151a, 151b, 151c) and the groove portion 152 (152a, 152b, 152c) may be repeatedly formed on the rib surface LL. Thus, when light incident on an interior of the lens barrel 110 is reflected from the rib surface LL, a reflection angle may be different depending on a position in which the light is reflected. Accordingly, the reflected light may be scattered, such that a flare phenomenon may be alleviated and improved.

In an example, referring to FIG. 3, a cross-section of the first region 150 may have a curved shape. For example, in the cross-section of the first region 150, a protrusion portion 151a, a groove portion 152a, and a connection portion 153a between the protrusion portion 151a and the groove portion 152a may all have curved surfaces having curvature.

As another example embodiment, referring to FIG. 4, a cross-section of the first region 150 may have a trapezoidal shape including a curved surface. For example, in the cross-section of the first region 150, a protrusion portion 151b, a groove portion 152b, and a connection portion 153b between the protrusion portion 151b and the groove portion 152b may be planar surfaces, and a curved surface R having curvature may be applied between the protrusion portion 151b and the connection portion 153b and between the groove portion 152b and the connection portion 153b. That is, at least three curved surfaces R may exist in a period.

As another example embodiment, referring to FIG. 5, a cross-section of the first region 150 may have a curved shape. For example, in the cross-section of the first region 150, a protrusion portion 151c and a groove portion 152c may be curved surfaces having curvature, and a connection portion 153c between the protrusion portion 151c and the groove portion 152c may be a planar surface.

According to the example embodiments of FIGS. 3 to 5, a distance in a direction, perpendicular to the optical axis direction, between adjacent protrusion portions 151 (151a, 151b, 151z) or between adjacent groove portions 152 (152a, 152b, 152c) may be greater than a distance in the optical axis direction between the adjacent protrusion portions 151 and the adjacent groove portions 152 (152a, 152b, 152c). In other words, in the patterns illustrated in FIGS. 3 to 5, a wavelength w may be greater than an amplitude d.

For example, in the patterns illustrated in FIGS. 3 to 5, the wavelength w may be 0.1 to 0.3 mm, and the amplitude d may be 0.01 to 0.03 mm. Such a pattern shape may be advantageous in reflecting light incident on a narrow reflection surface toward a wide region. In other words, the light incident on the narrow reflection surface may be scattered at a wide angle, and thus light incident on an image surface may be minimized.

FIGS. 6A to 8B illustrate an engraved or embossed pattern. Referring to FIGS. 6A to 8B, the first region 150 may include an engraved or embossed pattern from an inner diameter to an outer diameter of the rib surface LL. The pattern may be repeatedly formed at least two times from the inner diameter to the outer diameter of the rib surface LL.

Referring to FIGS. 6A to 8B, the pattern may include one of an embossed portion 157a that protrudes toward an object-side (or a subject) and an engraved portion 155 protruding toward an image-side (or image sensor). For example, the engraved portion 155 or the embossed portion 157a may be repeatedly formed at least two times from the inner diameter to the outer diameter of the rib surface LL.

In one or more examples, the engraved portion 155 and the embossed portion 157a may be repeatedly formed from the inner diameter to the outer diameter of the rib surface LL in a circumferential direction of the rib surface LL, and at least some of portions positioned at the same distance from an optical axis in the first region 150 may have different inclinations with respect to an optical axis direction.

For example, the engraved portion 155 and the embossed portion 157a may be formed to have a hemispherical or aspherical shape. Thus, even when light is incident on the portions positioned at the same distance from the optical axis, reflection surfaces may have different inclinations with respect to the optical axis direction.

In one or more examples, the pattern including the engraved portion 155 and the embossed portion 157a may be repeatedly formed on the rib surface LL. Thus, when light incident on an interior of the lens barrel 110 is reflected from the rib surface LL, a reflection angle may be different depending on a position in which the light is reflected. Accordingly, the reflected light may be scattered, such that a flare phenomenon may be alleviated and improved.

In particular, in the example embodiments of FIGS. 6A to 8B, even when portions where light is incident are positioned at the same distance from the optical axis, the portions may have different inclinations with respect to the optical axis direction, thereby further improving a flare reducing effect.

In an example, referring to FIGS. 6A and 6B, the first region 150 may include the engraved portion 155. For example, a cross-section of the first region 150 may include the engraved portion 155 and a planar portion 156 between the engraved portions 155. In the present example embodiment, an engraved pattern may include an interval in a circumferential direction of the rib surface LL and a direction away from the optical axis. The interval may be the planar portion 156, and the planar portion 156 may be continuously formed. That is, the engraved portion 155 may be discontinuously formed in the first region 150, and the engraved pattern may be a discontinuously repeated pattern.

In an example, referring to FIGS. 7A and 7B, the first region 150 may include an embossed portion 157a. For example, the cross-section of the first region 150 may include the embossed portion 157a and a planar portion 158 between the embossed portions 157a. In the present example embodiment, an embossed pattern may include an interval in a circumferential direction of the rib surface LL and a direction away from the optical axis. The interval may be the planar portion 158, and the planar portion 158 may be continuously formed. That is, the embossed portion 157a may be discontinuously formed in the first region 150, and the embossed pattern may be a discontinuously repeated pattern.

As another example embodiment, referring to FIGS. 8A and 8B, the first region 150 may include an embossed portions 157b continuously formed without an interval. For example, the embossed portion 157b may be continuously formed on the rib surface LL in a circumferential direction and a direction away from the optical axis. That is, the first region 150 may include an embossed pattern continuously repeated.

In the example embodiments of FIGS. 6A, 6B, 7A, and FIG. 7B, the engraved portion 155 or the embossed portion 157a may be formed on the rib surface LL at a predetermined angular interval along a circumference of a circle centered on the optical axis.

For example, the engraved portion 155 or the embossed portion 157a may be formed at an interval of 0.5 to 1.5 deg. The engraved portion 155 and the embossed portion 157a may be formed at an interval based on an angle, and thus the engraved portion 155 or the embossed portion 157a formed on portions positioned at different distances from the optical axis may have different distance intervals in a circumferential direction. However, an interval in a direction away from the optical axis direction may be constant.

According to the example embodiments of FIGS. 6A to 8B, a maximum length in a direction, perpendicular to the optical axis of the engraved portion 155 or the embossed portion 157a, may be longer than a maximum length in the optical axis direction of the engraved portion 155 or the embossed portion 157a. In other words, in the patterns illustrated in FIGS. 6A to 8B, a diameter Φ of the engraved portion 155 or the embossed portion 157a may be greater than a depth d' of the engraved portion 155 or the embossed portion 157a.

As non-limiting examples, in FIGS. 6A, 6B, 7A, and FIG. 7B, a diameter Φ of the engraved portion 155 or the embossed portion 157a may be 0.02 to 0.1 mm, and a depth d' of the engraved portion 155 or the embossed portion 157a may be shorter than the diameter Φ. Additionally, in FIGS. 8A and 8B, as non-limiting examples, a diameter Φ of the embossed portion 157b may be 0.2 to 0.3 mm, and a depth d' of the embossed portion 157b may be shorter than the diameter Φ. Such a pattern shape may be advantageous in reflecting light incident on a narrow reflection surface toward a wide region. In other words, the light incident on the narrow reflection surface may be scattered at a wide angle, and thus light incident on an image surface may be minimized.

When the plurality of lenses L are mounted in the lens barrel 110, the first region 150 described above may be provided in some or all of the plurality of lenses L mounted in the lens barrel 110.

Additionally, although the drawings illustrate that the first region 150 is provided on a surface facing an object-side, the first region 150 may be provided on a surface facing an image-side, or may be provided on both surfaces.

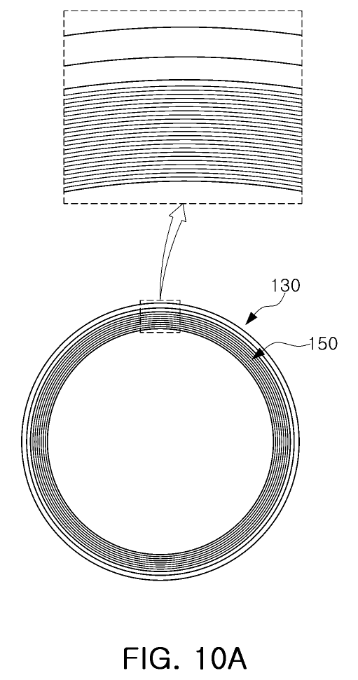

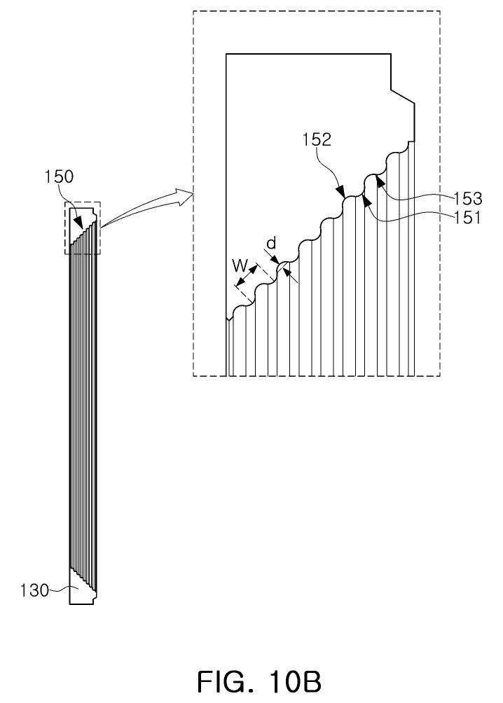

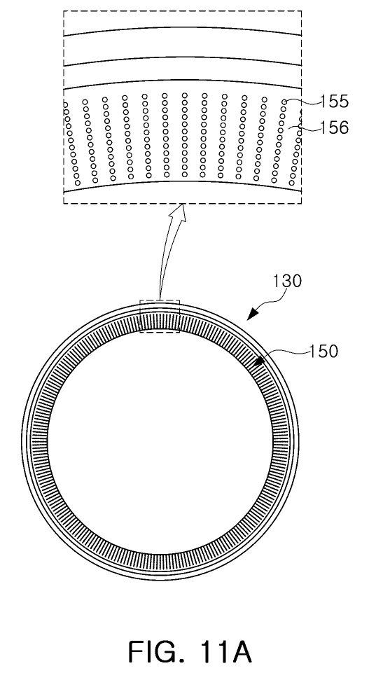

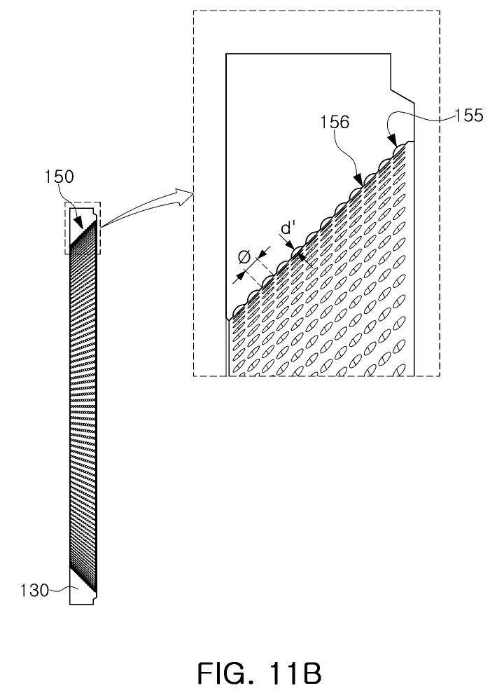

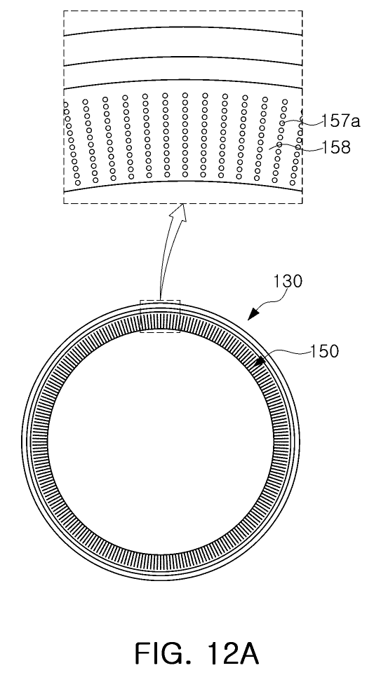

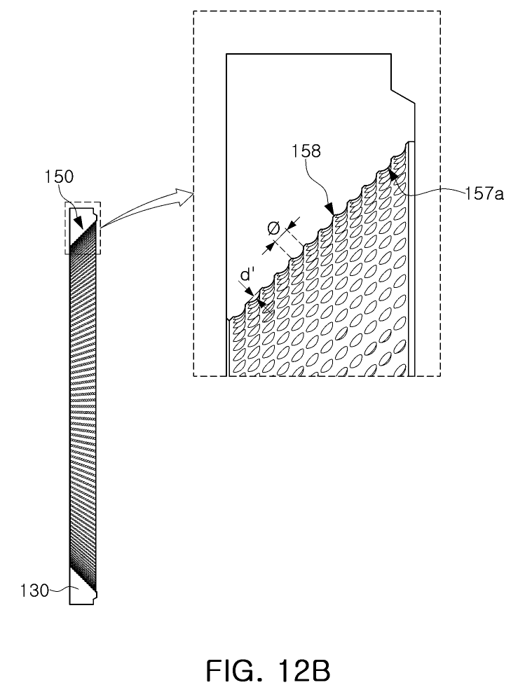

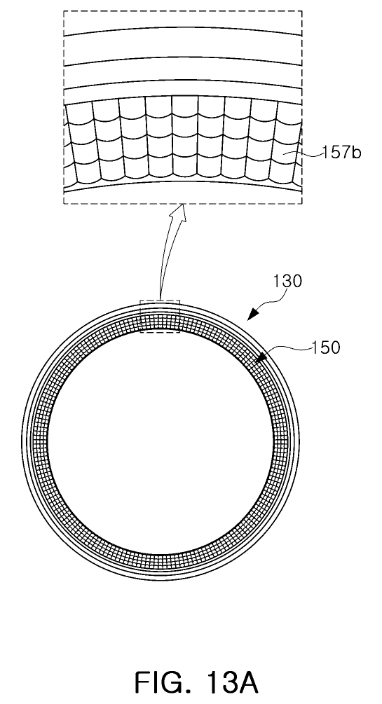

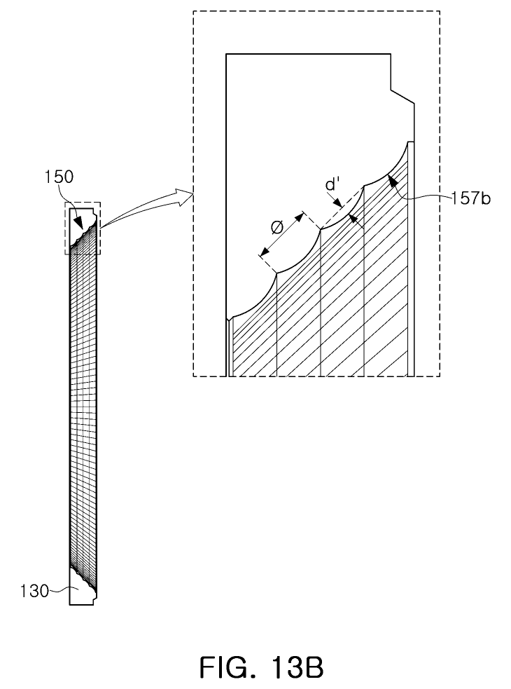

FIG. 9 is a cross-sectional view of an example camera module, in accordance with one or more embodiments. FIGS. 10A to 13B are enlarged views of a first region of a press-fit ring, in accordance with one or more embodiments.

Referring to FIG. 10A, in an example, the first region 150 may be formed on an inner circumferential surface of the press-fit ring 130. The first region 150 may be a region in which a pattern including a curved surface is repeatedly formed, and may be formed on a portion of the inner circumferential surface of the press-in ring 130, preferably on the entire inner circumferential surface of the press-fit ring 130. When the first region 150 is formed on a portion of the inner peripheral surface of the press-fit ring 130, the inner peripheral surface of the press-fit ring 130 may include the first region 150 and the second region 160.

Referring to FIGS. 10A and 10B, the first region 150 may include a wave-shaped pattern spreading from an object-side (or subject) to an image-side (or image sensor) on the inner circumferential surface of the press-fit ring 130.

The pattern may include the protrusion portion 151 protruding toward an optical axis and the groove portion 152 protruding toward an inner circumferential surface of the lens barrel 110. For example, the protrusion portion 151 and the groove portion 152 may be repeatedly formed from the object-side (or the subject) to the image-side on the inner circumferential surface of the press-fit ring 130.

In one or more examples, portions positioned at the same distance from the optical axis in the first region 150 may have the same inclination with respect to an optical axis direction. For example, the portions positioned at the same distance from the optical axis in the first region 150 may be the protrusion portion 151 or the groove portion 152.

In one or more examples, the pattern including the protrusion portion 151 and the groove portion 152 may be repeatedly formed on the inner circumferential surface of the press-fit ring 130. Thus, when light incident on an interior of the lens barrel 110 is reflected from the press-fit ring 130, a reflection angle may be different depending on a position in which the light is reflected. Accordingly, the reflected light may be scattered, such that a flare phenomenon may be alleviated and improved.

In an example, referring to FIGS. 10A and 10B, a cross-section of the first region 150 may have a curved shape. For example, in the cross-section of the first region 150, the protrusion portion 151, the groove portion 152, and a connection portion 153 between the protrusion portion 151 and the groove portion 152 may all have curved surfaces having curvature. However, the shape of the pattern is not limited thereto, and the first region 150 may include a pattern having the shape illustrated in FIG. 4 or FIG. 5.

Additionally, according to the present example embodiment, a wavelength w of the pattern may be greater than an amplitude d. Referring to FIG. 10B, the wavelength w of the pattern may refer to a distance between adjacent protrusion portions 151 or between adjacent groove portions 152, and the amplitude d may refer to a distance from a most protruding portion of the protrusion portion 151 to a most recessed portion of the groove portion 152.

For example, in the patterns illustrated in FIGS. 10A and 10B, the wavelength w may be, as only examples, 0.1 to 0.3 mm, and the amplitude d may be, as only examples, 0.01 to 0.03 mm. Such a pattern shape may be advantageous in reflecting light incident on a narrow reflection surface toward a wide region. In other words, the light incident on the narrow reflection surface may be scattered at a wide angle, and thus light incident on an image surface may be minimized.

FIGS. 11A to 13B illustrate an engraved and embossed pattern. Referring to FIGS. 11A to 13B, the first region 150 may include an engraved or embossed pattern from an object-side to an image-side on the inner circumferential surface of the press-fit ring 130.

Referring to FIGS. 11A to 13B, the pattern may include one of an embossed portion 157a that protrudes toward the optical axis and an engraved portion 155 recessed from the inner circumferential surface of the press-fit ring 130. The engraved portion 155 or the embossed portion 157a may be repeatedly formed from the object to the image in a circumferential direction on the inner circumferential surface of the press-fit ring 130.

In one or more examples, some of portions positioned at the same distance from the optical axis in the first region 150 may have different inclinations with respect to the optical axis direction. For example, the engraved portion 155 or the embossed portion 157a may be formed to have a hemispherical or aspherical shape. Thus, even when light is incident on the portions positioned at the same distance from the optical axis, reflection surfaces may have different inclinations with respect to the optical axis direction.

In one or more examples, the pattern including the engraved portion 155 and the embossed portion 157a may be repeatedly formed on the inner circumferential surface of the press-in ring 130. Thus, when light incident on an interior of the lens barrel 110 is reflected from the press-in ring 130, a reflection angle may be different depending on a position in which the light is reflected. Accordingly, the reflected light may be scattered, such that a flare phenomenon may be alleviated and improved.

In particular, in the example embodiments of FIGS. 11A to 13B, even when portions where light is incident are positioned at the same distance from the optical axis, the portions may have different inclinations with respect to the optical axis direction, thereby further improving a flare reducing effect.

In an example, referring to FIGS. 11A and 11B, the first region 150 may include an engraved portion 155. For example, a cross-section of the first region 150 may include the engraved portion 155 and the planar portion 156 disposed between the engraved portions 155. In the present example embodiment, an engraved pattern may include an interval in a circumferential direction of the inner circumferential surface of the press-fit ring 130 and a direction away from the optical axis. The interval may be the planar portion 156, and the planar portion 156 may be continuously formed. That is, the engraved portion 155 may be discontinuously formed in the first region 150, and the engraved pattern may be a discontinuously repeated pattern.

In an example, referring to FIGS. 12A and 12B, the first region 150 may include the embossed portion 157a. For example, the cross-section of the first region 150 may include the embossed portion 157a and the planar portion 158 disposed between the embossed portions 157a. In the present example embodiment, an embossed pattern may include an interval in a circumferential direction of the inner circumferential surface of the press-fit ring 130 and a direction away from the optical axis. The interval may be the planar portion 158, and the planar portion 158 may be continuously formed. That is, the embossed portion 157a may be discontinuously formed in the first region 150, and the embossed pattern may be a discontinuously repeated pattern.

In an example, referring to FIGS. 13A and 13B, the first region 150 may include the embossed portions 157b that are continuously formed without an interval. For example, the embossed portion 157b may be continuously formed in a circumferential direction of the inner circumferential surface of the press-fit ring 130 and a direction away from the optical axis. That is, the first region 150 may include an embossed pattern that is continuously repeated.

In the example embodiments of FIGS. 11A, 11B, 12A, and FIG. 12b, the engraved portion 155 or the embossed portion 157a may be formed on the inner circumferential surface of the press-fit ring 130 at a predetermined angular interval along a circumference of a circle centered on the optical axis.

For example, referring to FIGS. 11A, 11B, 12A, and FIG. 12b, the engraved portion 155 or the embossed portion 157a may be formed at an interval of, as only examples, 0.5 to 1.5 deg. The engraved portion 155 and the embossed portion 157a may be formed at an interval based on an angle, and thus the engraved portion 155 or the embossed portion 157a formed on portions positioned at different distances from the optical axis may have different distance intervals in a circumferential direction. However, an interval in a direction away from the optical axis direction may be constant.

According to the example embodiments of FIGS. 11A to 13B, a maximum length in a direction, perpendicular to the optical axis of the engraved portion 155 or the embossed portion 157, may be longer than a maximum length in the optical axis direction of the engraved portion 155 or the embossed portion 157. In other words, in the patterns illustrated in FIGS. 10A to 12B, a diameter Φ of the engraved portion 155 or the embossed portion 157 may be greater than a depth d' of the engraved portion 155 or the embossed portion 157.

For example, in FIGS. 11A, 11B, 12A, and FIG. 12B, the diameter Φ of the engraved portion 155 or the embossed portion 157a may be, as examples, 0.01 to 0.1 mm, and the depth d' of the engraved portion 155 or the embossed portion 157a may be shorter than the diameter Φ. Additionally, in FIGS. 12A and 12B, a diameter Φ of the embossed portion 157b may be, as examples, 0.2 to 0.3 mm, and a depth d' of the embossed portion 157b may be shorter than the diameter Φ. Such a pattern shape may be advantageous in reflecting light incident on a narrow reflection surface toward a wide region. In other words, the light incident on the narrow reflection surface may be scattered at a wide angle, and thus light incident on an image surface may be minimized.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
at least one lens;
a lens barrel configured to accommodate the at least one lens;
a press-fit ring disposed on the lens barrel, and configured to fix the at least one lens; and
an image sensor disposed in an optical axis direction with respect to the at least one lens,
wherein the press-fit ring comprises a first region in which a pattern including a curved surface is repeatedly formed on an inner circumferential surface thereof.

2. The camera module of claim 1, wherein portions of the pattern positioned at a same distance from the optical axis in the first region are configured to have a same inclination with respect to the optical axis direction.

3. The camera module of claim 1, wherein the pattern comprises a protrusion portion that protrudes toward the optical axis, and a groove portion that protrudes toward an inner circumferential surface of the lens barrel.

4. The camera module of claim 1, wherein the pattern comprises one of an embossed portion that protrudes toward the optical axis, and an engraved portion that is recessed from the inner circumferential surface.

5. The camera module of claim 1, wherein:
the at least one lens comprises a rib surface, and
the rib surface comprises the first region disposed on a surface that is perpendicular to the optical axis direction.

6. The camera module of claim 1, wherein the pattern is a wave-shaped pattern which spreads from an object-side to an image-side on the inner circumferential surface of the press-fit ring.
